(19) United States
(12) Patent Application Publication
(10) Pub. No.: US 2023/0282391 A1
(43) Pub. Date: Sep. 7, 2023

(54) SYSTEM AND METHOD OF MEASURING FOR MANUFACTURE AND DEPLOYMENT OF DISTRIBUTION CABLE ASSEMBLIES

(71) Applicant: CORNING RESEARCH & DEVELOPMENT CORPORATION, Corning, NY (US)

(72) Inventors: Terry Lee Cooke, Hickory, NC (US); Michael Todd Faulkner, Granite Falls, NC (US); Lars Kristian Nielsen, Denver, NC (US)

(21) Appl. No.: 18/197,297

(22) Filed: May 15, 2023

Related U.S. Application Data
(63) Continuation of application No. PCT/US2021/059436, filed on Nov. 16, 2021.
(60) Provisional application No. 63/118,311, filed on Nov. 25, 2020.

(51) Int. Cl. H01B 7/36; G01B 3/1056

(52) U.S. Cl. CPC H01B 7/365; G01B 3/1056

(57) ABSTRACT

Disclosed herein is a system and method of measuring for manufacture and deployment of distribution cable assemblies. The measurement includes a distribution cable ruler having at least one similar feature as a distribution cable of a distribution cable assembly. The at least one similar feature comprising at least one of an outer diameter, a bend radius, or a rigidity. The distribution cable ruler includes measurement indicia to facilitate measurement of a distribution length of the distribution cable of the distribution cable assembly. The method includes positioning a distribution cable ruler in a path intended for a distribution cable assembly. The method further includes measuring a distribution cable length of the distribution cable ruler using measurement indicia of the distribution cable ruler.

### CROSS-REFERENCE TO RELATED APPLICATION

This application is a continuation of International Application No. PCT/US2021/059436 filed Nov. 16, 2021, which claims the benefit of priority under 35 U.S.C. § 119 of U.S. Provisional Application Ser. No. 63/118,311, filed on Nov. 25, 2020, the content of which is relied upon and incorporated herein by reference in its entirety.

### BACKGROUND

The present disclosure relates to systems and methods of measuring dimensions for manufacture and deployment of preconnectorized optical distribution cable assemblies.

Data center design and cabling-infrastructure architecture are increasingly large and complex, which requires incorporation of high-density optical components (e.g., optical fiber densities), such as to compensate for limited space and meet increasing performance demands. Many data centers include fiber optic cables, which have a number of advantages in waveguide systems compared to bulky traditional conductor cables (e.g., copper). Fiber optic cables provide wide bandwidth data transmission, transport multiple signals and traffic types, and/or deliver high-speed Internet access, especially as data rates increase. Data centers utilize multi-fiber cables to interconnect and provide signals between building distribution frames and/or to individual unit centers (e.g., computer servers). However, the labor and cost of deploying such multi-fiber cable networks for a data center can be high. Thus, there is a desire to reduce the time and costs associated with data center construction, particularly regarding cabling installation.

One way to improve optical infrastructure installation efficiency is to pre-engineer infrastructure components. Such components (e.g., fiber optic cables) may be preterminated in a factory with connectors installed, tested, and packaged for fast, easy, and safe installation at a data center. In this way, the installer merely needs to unpack the components, pull or route the preconnectorized fiber optic cable assembly, snap-in connectors, and/or install patch cords to end equipment, etc. This saves a significant amount of time, effort, and costs compared to on-site connectorization and assembly of cables.

To pre-engineer, such components involve measuring dimensions at the data center. Accurate measurements decrease costs and rates of failure. In particular, overestimating lengths can result in unnecessary expenses due to additional material, as well as unwanted slack that requires additional storage. Underestimating lengths can results in an unusable product for failing to reach the necessary ports. Part of the difficulty in measuring such dimensions is trying to account for mechanical features (e.g., stiffness, bend radius, etc.) that may affect the overall length of the product.

### SUMMARY

On embodiment of the disclosure relates to a measurement system for manufacture and deployment of at least a portion of a distribution cable assembly. The measurement system includes a distribution cable ruler having at least one similar feature as a distribution cable of a distribution cable assembly. The at least one similar feature includes at least one of an outer diameter, a bend radius, or a rigidity. The distribution cable ruler includes measurement indicia to facilitate the measurement of a distribution length of the distribution cable of the distribution cable assembly.

An additional embodiment of the disclosure relates to a method of measuring dimensions for manufacture and deployment of at least a portion of a distribution cable assembly. The method includes positioning a distribution cable ruler in a path intended for a distribution cable assembly. The distribution cable ruler has at least one similar feature as a distribution cable of a distribution cable assembly. The at least one similar feature includes at least one of an outer diameter, a bend radius, or a rigidity. The method further includes measuring a distribution cable length of the distribution cable ruler using measurement indicia of the distribution cable ruler.

Additional features and advantages will be set out in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1A is a perspective view of a section of fiber optic distribution cable, in accordance with aspects of the present disclosure.

FIG. 1B is a perspective view of a section of a subunit cable of the distribution cable of FIG. 1A, in accordance with aspects of the present disclosure.

FIG. 2A is a cross-sectional view of an embodiment of the distribution cable of FIGS. 1A-1B, in accordance with aspects of the present disclosure.

FIG. 2B is a cross-sectional view of another embodiment of the distribution cable of FIGS. 1A-1B, in accordance with aspects of the present disclosure.

FIG. 3A is a schematic view of an embodiment of a preconnectorized distribution cable assembly, including the distribution cable of FIGS. 1A-2B and illustrating a distribution tether with MTP connectors and eight subunit cables with MTP connectors.

FIG. 3B is a schematic view of another embodiment of a preconnectorized distribution cable assembly, including the distribution cable of FIGS. 1A-2B and illustrating a distribution tether with MTP connectors and eight tether subunits with LC uniboot connectors.

FIG. 3C is a schematic view of another embodiment of a preconnectorized distribution cable assembly, including the distribution cable of FIGS. 1A-2B and illustrating multiple distribution tethers and multiple tap tethers.

FIG. 4A is a schematic view of a data center for use with the distribution cable assemblies of FIGS. 3A-3C, in accordance with aspects of the present disclosure.

FIG. 4B is a schematic view of equipment racks and distribution cables in the data center of FIG. 4A, in accordance with aspects of the present disclosure.

FIG. 5 is a view of a measurement system including a distribution cable ruler, a distribution tether ruler, and a tap tether ruler.

FIG. 6A is a perspective view of an embodiment of the distribution cable ruler of the measurement system of FIG. 5 with a transparent tube and a tape measure placed within the transparent tube.

FIG. 6B is a perspective view of an embodiment of the distribution cable ruler of the measurement system of FIG. 5 with measurement indicia applied to the tube.

FIG. 7A is another embodiment of the measurement system of FIG. 5 with a retractable distribution tether ruler and a plurality of tap tether rulers.

FIG. 7B is a close-up view of the retractable distribution tether ruler of FIG. 7A.

FIG. 8 is a close-up of a collar coupling the tap tether ruler to the distribution cable ruler.

FIG. 9 is a perspective view of a measurement system rolled up on a cable reel.

FIG. 10A is a perspective view of a data center, including distribution cable suspended by straps.

FIG. 10B is a perspective view illustrating measurements by the measurement system of FIG. 5 of the distribution tether length, distribution cable length, and tap tether length.

FIG. 10C is a side view of fiber optic cabinets illustrating measurements by the measurement system of FIG. 5 of tap spacing and tap tether length.

FIG. 11 is a flowchart of steps for using a measurement system in accordance with aspects of the present disclosure.

### DETAILED DESCRIPTION

Reference will now be made in detail to the presently preferred embodiments, examples of which are illustrated in the accompanying drawings. Whenever possible, the same reference numerals will be used throughout the drawings to refer to the same or like parts.

The embodiments set out below represent the information to enable those skilled in the art to practice the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

### Reference Numbers and Terminology

The use herein of ordinals in conjunction with an element is solely for distinguishing what might otherwise be similar or identical labels, such as “first layer” and “second layer,” and does not imply a priority, a type, an importance, or other attributes, unless otherwise stated herein.

The term “about” used herein in conjunction with a numeric value means any value that is within a range of ten percent greater than or ten percent less than the numeric value.

As used herein, the articles “a” and “an” in reference to an element refers to “one or more” of the element unless otherwise explicitly specified. The word “or” as used herein is inclusive unless contextually impossible. For example, the recitation of A or B means A, or B, or both A and B.

The phrase “surface” as used herein refers to an outermost portion of an item and includes a thickness of the outermost portion of the item. The precise thickness is generally not relevant to the embodiments unless otherwise discussed herein. For example, a layer of material has a surface that includes the outermost portion of the layer of material as well as some depth into the layer of material, and the depth may be relatively shallow or may extend substantially into the layer of material. The sub-wavelength openings discussed herein are formed in a surface, but whether the depth of the sub-wavelength openings extends past the depth of the surface is generally not relevant to the embodiments.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

The use herein of “proximate” means at, next to, or near.

The terms “left,” “right,” “top,” “bottom,” “front,” “back,” “horizontal,” “parallel,” “perpendicular,” “vertical,” “lateral,” “coplanar,” and similar terms are used for convenience of describing the attached figures and are not intended to limit this disclosure. For example, the terms “left side” and “right side” are used with specific reference to the drawings as illustrated, and the embodiments may be in other orientations in use. Further, as used herein, the terms “horizontal,” “parallel,” “perpendicular,” “vertical,” “lateral,” etc., include slight variations that may be present in working examples.

As used herein, the terms “optical communication,” “in optical communication,” and the like mean that two elements are arranged such that optical signals are passively or actively transmittable therebetween via a medium, such as but not limited to, an optical fiber, connectors, free space, index-matching structure or gel, reflective surface, or other light directing or transmitting means.

### Data Centers and Fiber Optic Cable Assemblies

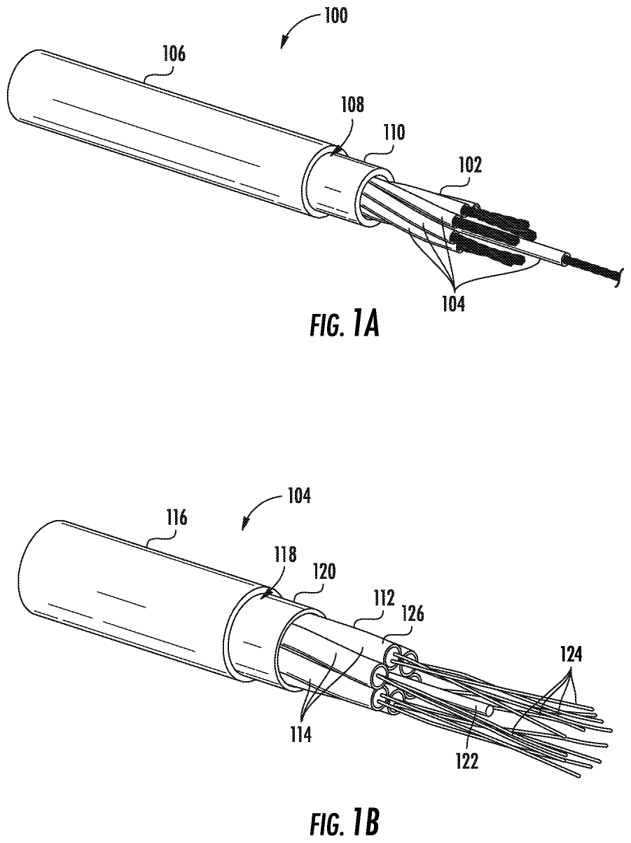

FIGS. 1A-1B are views of a section of a fiber optic distribution cable 100, in accordance with aspects of the present disclosure. Referring to FIG. 1A, the distribution cable 100 includes a cable bundle 102 (may also be referred to herein as a cable core) of a plurality of subunit cables 104 and a distribution jacket 106 (may also be referred to as outer jacket, etc.) defining a distribution interior 108. The cable bundle 102 of the subunit cables 104 is disposed in the distribution interior 108 of the distribution jacket 106.

In certain embodiments, a strain-relief component 110 may be disposed within the distribution interior 108 of the distribution jacket 106 between the cable bundle 102 of the subunit cables 104 and the distribution jacket 106. The strain-relief component 110 surrounds and/or is interspersed among the cable bundle 102 of the subunit cables 104.

In certain embodiments, an outer layer of a plurality of subunit cables 104 is stranded around an inner layer of subunit cables 104 to provide higher fiber densities. This reduces any stress or strain concentrations on any single subunit cable 104 (e.g., from bending of the distribution cable 100). In certain embodiments, a central strength element (not shown) may be provided, and the subunit cables 104 may be stranded around the central strength element. In yet other cable applications, stranding may not be used and the subunit cables 104 may run substantially parallel through the distribution cable 100.

Referring to FIG. 1B, each subunit cable 104 (may also be referred to herein as a micro module, etc.) includes a subunit bundle 112 (may also be referred to herein as a subunit core) of a plurality of tether cables 114 (may also be referred to herein as tether subunits) and a subunit jacket 116 defining a subunit interior 118. The subunit bundle 112 of the tether cable 114 is disposed in the subunit interior 118 of the subunit jacket 116.

In certain embodiments, a strain-relief component 120 may be disposed within the subunit interior 118 of the subunit jacket 116 between the subunit bundle 112 of the tether cables 114 and the subunit jacket 116. The strain-relief component 120 surrounds and/or is interspersed among the subunit bundle 112 of the subunit cables 104. In certain embodiments, the strain-relief component 120 may be, for example, a layer of longitudinally-extending yarns for absorbing tensile loads on the subunit bundle 112. In certain embodiments, the strain-relief component 120 includes a dispersed layer of aramid strands in the region between the subunit jacket 116 and the subunit bundle 112 of tether cables 114.

In certain embodiments, a central strength element 122 may be disposed in a center of the subunit bundle 112, and thereby, within the subunit interior 118 of the subunit jacket 116. The tether cables 114 may be stranded (e.g., helically twisted) around the central strength element 122. In certain embodiments, an outer layer of a plurality of tether cables 114 is stranded around an inner layer of tether cables 114 to provide higher fiber densities. In yet other cable applications, stranding may not be used and the tether cables 114 may run substantially parallel through the subunit cable 104. The central strength element 122 provides strain-relief and absorbs loads from the tether cables 114.

In certain embodiments, as illustrated, the subunit bundle 112 is stranded such that the tether cables 114 are helically twisted around a longitudinal axis of the subunit bundle 112. This reduces any stress or strain concentrations on any one tether cable 114 (e.g., from bending of the distribution cable 100 (see FIG. 1) and/or subunit cable 104). Each tether cable 114 includes one or more optical fibers 124 (may also be referred to herein as optical fiber waveguides).

In certain embodiments, the strain-relief component 110 and/or strain-relief component 120 may utilize tensile yarns as tension relief elements that provide tensile strength to the cables 100, 104, 114. In certain embodiments, a preferred material for the tensile yarns is aramid (e.g., KEVLAR®), but other tensile strength materials could be used, such as high molecular weight polyethylenes (e.g., SPECTRA® fiber and DYNEEMA® fiber, Teijin Twaron® aramids, fiberglass, etc.).

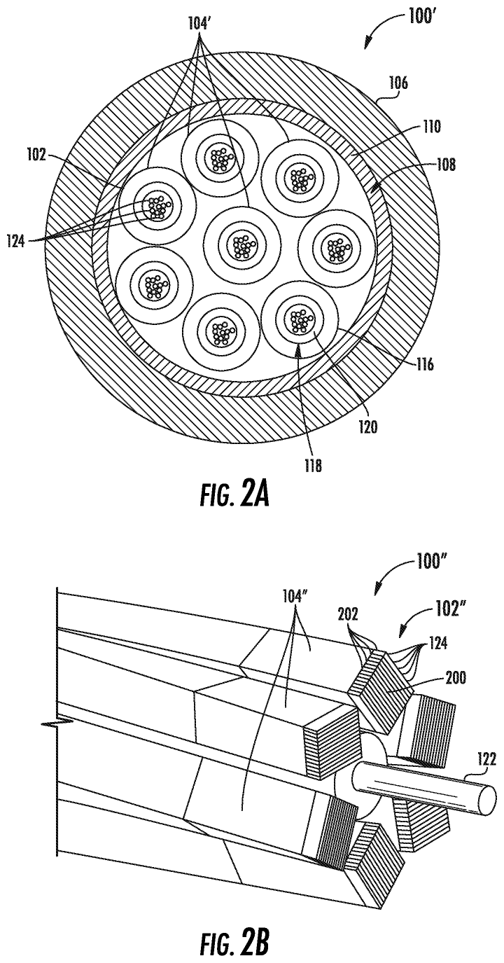

FIG. 2A is a cross-sectional view of an embodiment of the distribution cable 100′ of FIGS. 1A-1B, in accordance with aspects of the present disclosure. Each of the subunit cables 104′ includes optical fibers 124 loosely disposed within the subunit cable 104′ (e.g., in an essentially parallel array). The subunit cable 104′ may be further encased in an interlocking armor for enhanced crush resistance. FIG. 2B is a cross-sectional view of another embodiment of the distribution cable 100″. Each of the subunit cables 104″ of the cable bundle 102″ is a stack 200 of fiber ribbons 202. Each fiber ribbon 202 includes a plurality of optical fibers 124.

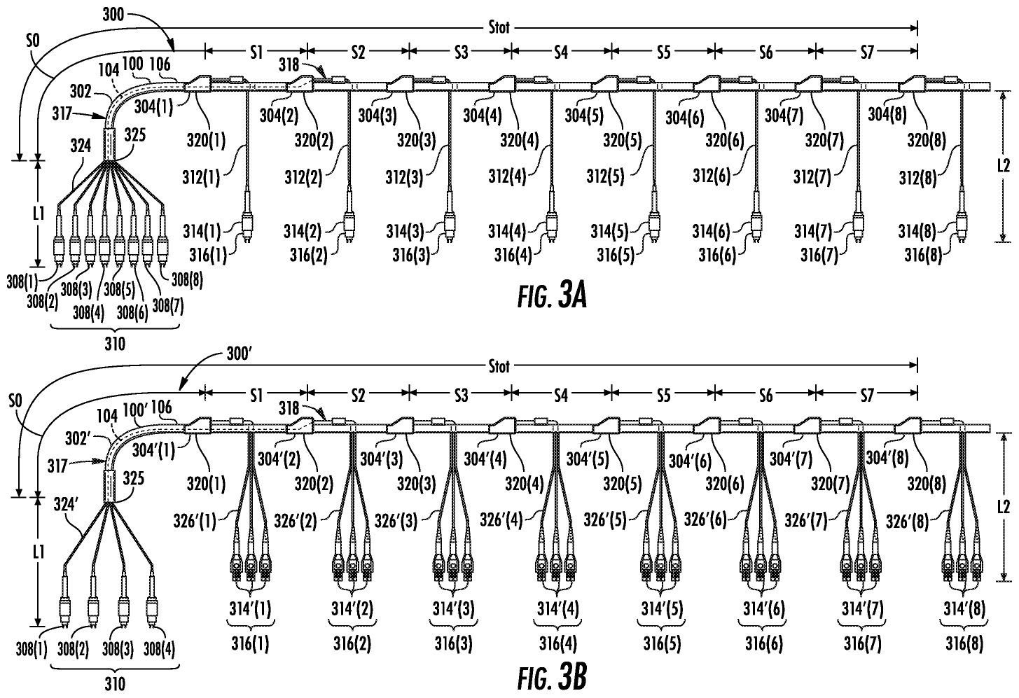

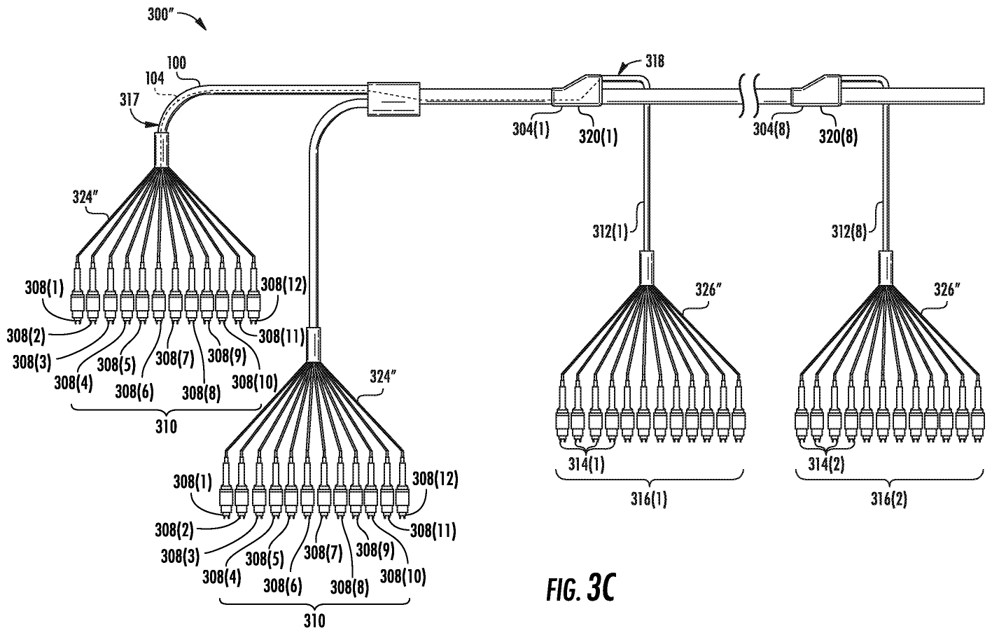

FIGS. 3A-3C are embodiments of a distribution cable assembly 300 incorporating the distribution cable of FIGS. 1A-1B. Referring to FIG. 3A, the distribution cable assembly 300 includes a distribution subunit 302 (may also be referred to herein as a main subassembly) and a plurality of tap subunits 304(1)-304(8) (may also be referred to herein as a branch subassembly, drop subunit, etc.). The distribution subunit 302 includes a distribution cable 100 (may be referred to as a distribution cable portion) and distribution connectors 308 at a distribution end 310 (may also be referred to herein as upstream end). Each of the plurality of tap subunits 304(1)-304(8) includes a tap cable 312(1)-312(8) (may also be referred to herein as a drop cable or tap cable portion) and tap connectors 314(1)-314(8) at a tap end 316(1)-316(8) (may also be referred to herein as downstream end). In certain embodiments, subunit cables 104 extend from the distribution connector 308 to respectively one of the plurality of tap connectors 314(1)-314(8), each at a different tap point 320(1)-320(8) (may also be referred to herein as drop point, terminated access point, etc.) along a length of the distribution cable 100. For example, subunit cable 104 extends from the distribution connector 308 through the distribution cable 100 to the tap connector 314(2). The spacing S1-S7 between tap points 320(1)-320(8) depends on the application and cabling requirements.

The distribution connectors 308(1)-308(8) are in optical communication with the tap connectors 314(1)-314(8) (may be referred to generally as tap connectors 314), where the distribution cable assembly 300 is pre-connectorized, such as for connection to a patch panel (e.g., at a goalpost). The distribution cable assembly 300 includes a distribution portion 317 of the subunit cable 104 that extends for a predetermined length S0 from the distribution connectors 308(1)-308(8) through the distribution cable 100 to the first tap portion 318(1). The distribution cable assembly 300 further includes tap portions 318 of the subunit cable 104 that extend from the distribution cable 100 to the tap connectors 314(1)-314(8). Accordingly, the total length Stot of the distribution cable 100 includes S0-S7.

In certain embodiments, as illustrated in FIG. 3A, the distribution subunit 302 includes a distribution tether 324 (may be referred to as a distribution tether portion) at the distribution end 310. In certain embodiments, the distribution cable assembly 300 includes multiple distribution tethers 324 and multiple tap tethers. The distribution tether 324 may be pre-connectorized and extend a predetermined length L1 from an end 325 of the distribution jacket 106. Further, the distribution tether 324 includes distribution connectors 308(1)-308(8) coupled to ends of the distribution tether 324. Similarly, the tap subunits 304(1)-304(8) are pre-connectorized such that the tap cables 312(1)-312(8) extend a predetermined length L2 from the distribution jacket 106. Further, the tap subunits 304(1)-304(8) include tap connectors 314(1)-314(8) coupled to tap ends 316(1)-316(8) of the tap subunits 304(1)-304(8).

In certain embodiments, as illustrated in FIG. 3B, the distribution cable assembly 300′ includes the distribution subunit 302′ with a distribution tether 324′ at the distribution end 310, which is pre-connectorized. Further, the tap subunits 304′(1)-304′(8) includes tap tethers 326′(1)-326′(8) at the tap ends 316′(1)-316′(8), which is pre-connectorized with tap connectors 314′(1)-314′(8).

FIG. 3C is a schematic view of another embodiment of a preconnectorized distribution cable assembly 300″ illustrating multiple distribution tethers 324″ and multiple tap tethers 326″. Such configurations may be used to increase fiber density and/or for certain routing configurations, such as by routing each distribution tether 324″ to each tap tether 326″. The distribution connectors 308(1)-308(12) of the distribution tethers 324″ are in optical communication with the tap connectors 314(1)-314(2) of the tap tethers 326″.

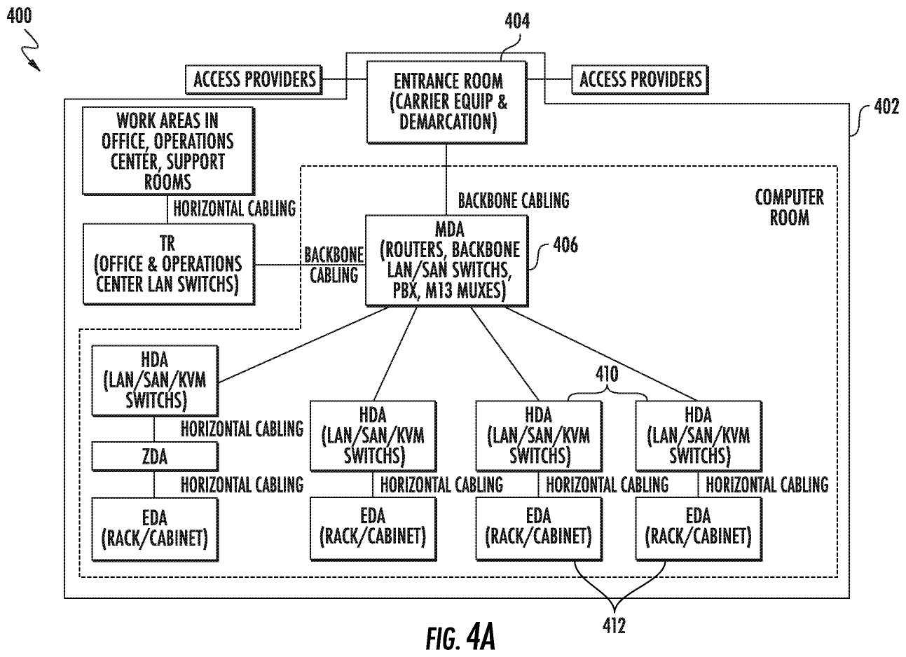

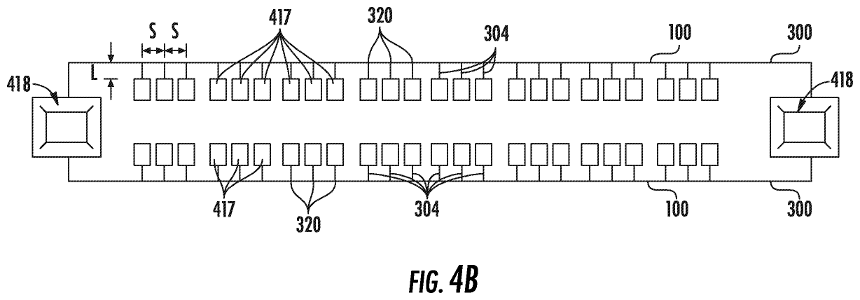

FIG. 4A is a schematic view of a data center, in accordance with aspects of the present disclosure. In particular, FIG. 4A illustrates a topology of an exemplary data center 400. The data center 400 includes a set of spaces delineated by function, which may be housed in a single building 402. For example, the data center may include one or more entrance rooms 404 or entry points. The entrance room 404 is conventionally the space used for interfacing the structured cabling infrastructure of the data center 400 with inter-building cabling. Each entrance room 404 may be configured to act as a termination point for external optical connections to a wide area network (WAN) and/or other data center buildings 400.

The MDA 406 may serve one or more Horizontal Distribution Areas (HDAs) 410 or Equipment Distribution Areas (EDAs) 412. The HDA 410 may include LAN switches, SAN switches, and Keyboard/Video/Mouse (KVM) switches for equipment located in the EDAs 412. The EDA 412 contains the end equipment, including computer systems and telecommunications equipment typically organized in racks or cabinets.

FIG. 4B is a schematic view of equipment racks and distribution cables in a data center, in accordance with aspects of the present disclosure. A preconfigured and preconnectorized cable such as distribution cable assembly 300, 300′ (referred to herein generally as distribution cable assembly 300) may be used to connect the servers 417 in the racks or cabinets in the EDA 412 to the MDA 406 via one or more edge of rack units 418 (also referred to as goalposts). The exact drop or tap locations and run lengths for the individual tap subunits 304, 304′, 304″ (referred to herein generally as tap subunit 304) may be pre-engineered and pre-connectorized to replace the many individual cables typically provided. The most efficient optical infrastructure is one in which all or most of the components are preterminated in the factory, and the cables are designed to fit efficiently in the confined spaces of the datacenter without excess cable. The installer simply unpacks the components, pulls the preconnectorized cable assembly into place, snaps in all of the connectors, and the system is up and running. Accordingly, the cable assembly 300, 300′, 300″ depicted in FIGS. 1A-3C may be particularly suitable for the structured cabling requirements of a datacenter.

In certain embodiments, the plurality of tap subunits 304 (e.g., premanufactured) of the distribution cable assembly 300 are spaced apart by a predetermined distance S and/or of a predetermined length L based on, for example, location in a data center and/or distance to specific equipment, etc. In particular, the distribution cable assembly 300 could be manufactured such that each individual tap subunit 304 has a predetermined length L according to the configuration of the data center, and where along the distribution cable 100 the tap subunit 304 will branch away. Further, the tap subunits 304 may be premanufactured such that each has a predetermined length L according to the configuration of the data center (e.g., spacing S between servers) and location along the distribution cable.

### Measurement Systems and Methods

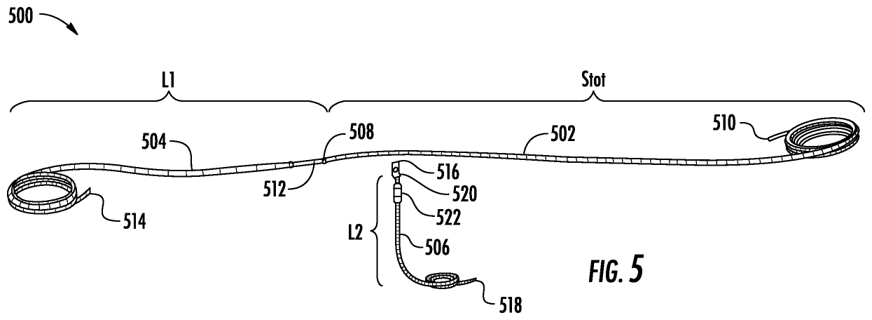

FIG. 5 is a view of a measurement system 500 for manufacture and deployment of at least a portion of a distribution cable assembly. In general, the measurement system 500 shares similar mechanical features or properties as the distribution cable assembly 300 to facilitate ease of and increase accuracy of measurements for manufacture and deployment of a preconfigured distribution cable assembly 300. In certain embodiments, the measurement system 500 is reusable and reconfigurable. In other embodiments, the measurement system 500 is permanently marked.

The measurement system 500 includes a distribution cable ruler 502 to measure a distribution cable length Stot for a distribution cable 100 of the distribution cable assembly 300, a distribution tether ruler 504 to measure a distribution tether length L1 for a distribution tether 324 of the distribution cable assembly 300, and a tap tether ruler 506 to measure a tap tether length L2 for a tap tether 326. Although reference is made to the tap tether 326, it is noted that the tap tether ruler 506 could be used to measure a single tap cable 312(1)-312(8) as in FIG. 3A.

The distribution cable ruler 502 includes a medial end 508 and a distal end 510. The distribution tether ruler 504 includes a medial end 512 attached to the medial end 508 of the distribution cable ruler 502. The distribution tether ruler 504 also includes a distal end 514. The tap tether ruler 506 includes a medial end 516 attached or configured to be attached along a length of the distribution cable ruler 502. The tap tether ruler 506 further includes a distal end 518.

The distribution cable ruler 502 facilitates measurement of a distribution cable length Stot of the distribution cable assembly 300. The distribution cable ruler 502 has at least one similar feature as a distribution cable 100 of a distribution cable assembly 300. The at least one similar feature includes at least one of an outer diameter, a bend radius, or a rigidity. In certain embodiments, the distribution cable ruler 502 has an outer diameter between 2.5 mm and 70 mm, a bend radius between 25 mm and 600 mm, and/or a length less than about 1,000 m. In certain embodiments, for lower fiber counts, the distribution cable ruler 502 has an outer diameter between 5 mm and 15 mm, a bend radius between 100 mm and 300 mm, and/or a length less than 200 m. In certain embodiments, for higher fiber counts, the distribution cable ruler 502 has an outer diameter between 10 mm and 35 mm, a bend radius between 50 mm and 200 mm, and/or a length less than 750 m.

The distribution tether ruler 504 is attached to an end of the distribution cable ruler 502 to facilitate measurement of a distribution tether length L1 of the distribution cable assembly 300. The distribution tether ruler 504 of the distribution cable assembly 300 has at least one similar feature as a distribution tether 324 of a distribution cable assembly 300. The at least one similar feature includes at least one of an outer diameter, a bend radius, or a rigidity. In certain embodiments, the distribution tether ruler 504 has an outer diameter between 0.8 mm and 20 mm, a bend radius between 12.5 mm and 400 mm, and/or a length less than about 8 m. In certain embodiments, for lower fiber counts, the distribution tether ruler 504 has an outer diameter between 1.6 mm and 5 mm, a bend radius between 25 mm and 100 mm, and/or a length less than 3 m. In certain embodiments, for higher fiber counts, the distribution cable ruler 502 has an outer diameter between 1.6 mm and 10 mm, a bend radius between 50 mm and 200 mm, and/or a length less than 6 m.

The tap tether ruler 506 is attached between ends of the distribution cable ruler 502 to facilitate measurement of a tap tether length L2 of the distribution cable assembly 300. The tap tether ruler 506 has at least one similar feature as a tap tether 326 of a distribution cable assembly 300. The at least one similar feature includes at least one of an outer diameter, a bend radius, or a rigidity. In certain embodiments, the distribution tether ruler 504 has an outer diameter between 0.8 mm and 20 mm, a bend radius between 12.5 mm and 400 mm, and/or a length less than 60 m. In certain embodiments, for lower fiber counts, the distribution tether ruler 504 has an outer diameter between 1.6 mm and 5 mm, a bend radius between 25 mm and 100 mm, and/or a length less than 15 m. In certain embodiments, for higher fiber counts, the distribution cable ruler 502 has an outer diameter between 1.6 mm and 10 mm, a bend radius between 50 mm and 200 mm, and/or a length less than 45 m.

In certain embodiments, the tap tether ruler 506 includes a connector 520 at a medial end 516 of the tap tether ruler 506. The connector 520 attached to or configured to attach to the distribution cable ruler 502. In certain embodiments, the tap tether ruler 506 includes an identifier 522 proximate the medial end 516. Accordingly, if multiple tap tether rulers 506 are used, each tap tether ruler 506 may be easily identified.

Generally, the distribution cable 100 has greater rigidity than the distribution tether 324 and/or tap tether 326. In certain embodiments, the distribution cable ruler 502 has a greater rigidity than the distribution tether ruler 504 and/or the tap tether ruler 506.

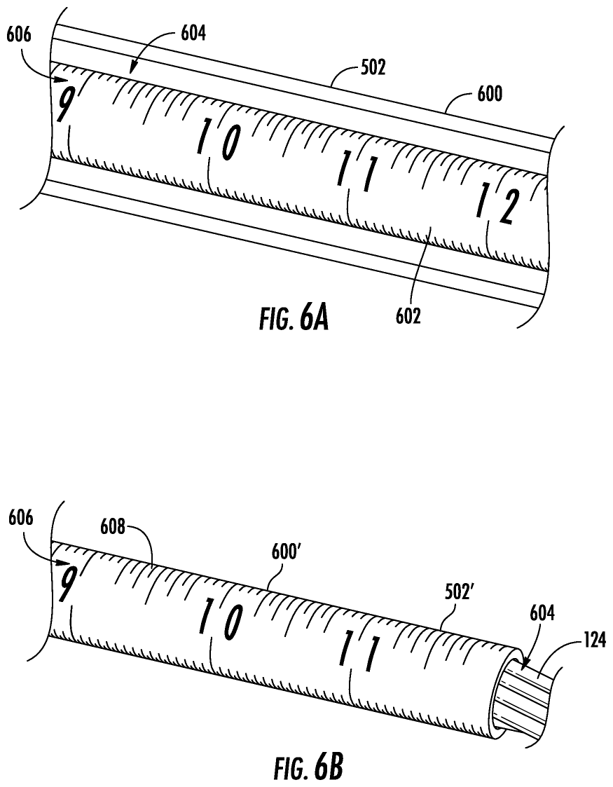

FIG. 6A is a perspective view of an embodiment of the distribution cable ruler 502 of the measurement system 500 with a tube 600 and a tape measure 602 placed within an interior 604 of the tube 600. At least a portion of the tube 600 is transparent to easily read the tape measure 602 placed in the interior 604. In certain embodiments, the tape measure 602 is flexible and includes at least one of linen, cloth, metallic, steel, and/or invar. The distribution cable ruler 502 includes measurement indicia 606 to facilitate measurement of a distribution length of the distribution cable 100 of the distribution cable assembly 300. The measurement indicia 606 includes English length measurement units and/or metric length measurement units. In certain embodiments, English length measurement units are provided on one side of the tape measure 602, and metric length measurement units are provided on the other side of the tape measure 602.

Although the distribution cable ruler 502 is shown specifically, a similar configuration could be used for the distribution tether ruler 504 and/or the tap tether ruler 506. In other words, in certain embodiments, the distribution cable ruler 502, the distribution tether ruler 504, and/or the tap tether ruler 506 includes a tube 600 with a flexible tape measure 602 positioned within the tube 600.

FIG. 6B is a perspective view of an embodiment of the distribution cable ruler 502′ of the measurement system 500 with measurement indicia 606 applied to an outer surface 608 of the tube 600′. In certain embodiments, the tube 600′ is the same or similar to the distribution jacket 106 of the distribution cable 100 of the distribution cable assembly 300. For example, in certain embodiments, the distribution jacket 106 includes the same material and/or same outer diameter of the distribution cable 100 of the distribution cable assembly 300. In certain embodiments, the distribution cable ruler 502 includes one or more fiber optic cables 124 positioned within the interior 604 of the tube 600′ to provide similar bend radius and/or rigidity. In certain embodiments, the tube 600′ of the distribution cable ruler 502 does not include fiber optic cables but instead is thicker, solid, or otherwise more rigid than the distribution jacket 106 of the distribution cable 100 to provide a similar rigidity as the distribution cable 100 (e.g., distribution jacket and optical fibers).

In certain embodiments, the distribution cable ruler 502, the distribution tether ruler 504, and/or the tap tether ruler 506 includes a tube 600 with measurement indicia 606 applied to the outer surface 608 of a distribution cable tube 600 of the distribution cable ruler. In certain embodiments, the tube 600 may be hollow or solid.

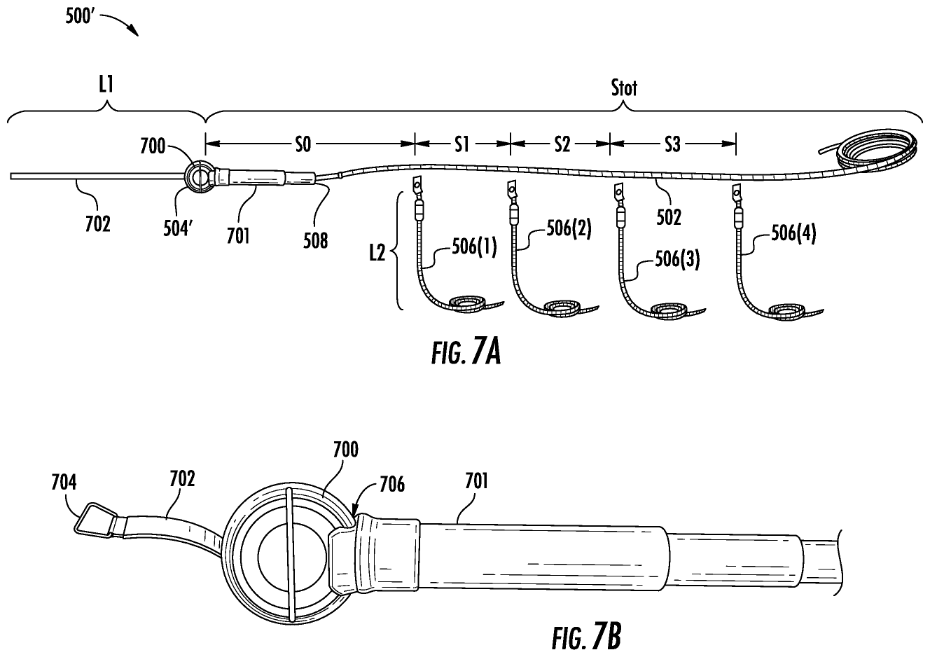

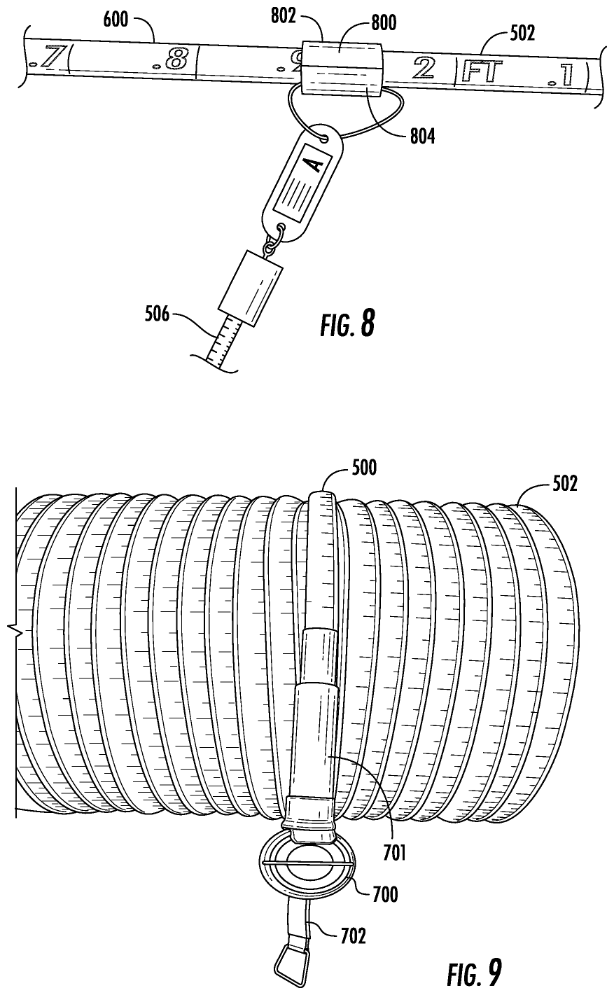

FIGS. 7A-7B illustrate another embodiment of the measurement system 500′ with a retractable distribution tether ruler 504′ and a plurality of tap tether rulers 506(1)-506(4) spaced apart by distances S1-S3. Although the distribution tether ruler 504′ is illustrated as retractable, in certain embodiments, the distribution cable ruler 502 and/or the plurality of tap tether rulers 506(1)-506(4) are also retractable.

The distribution tether ruler 504′ includes a housing 700 attached by a mount 701 to the medial end 508 of the distribution cable ruler 502 of the measurement system 500′. In certain embodiments, the distribution tether ruler 504′ is spring-loaded to retract the tape measure 702 of the distribution tether ruler 504′ back into the housing 700. In certain embodiments, the distribution tether ruler 504′ includes a handle 704 attached to an end of the tape measure 702 to facilitate withdrawal of the tape measure 702 from the housing 700. In certain embodiments, the distribution tether ruler 504′ is removably attached to the mount 701 (e.g., by a slot 706) to accept different types of tape measuring devices. In such a configuration, the mount 701 can be fixed to the medial end 508 of the distribution cable ruler 502 (e.g., by epoxy).

In certain embodiments, the distribution cable ruler 502, the distribution tether ruler 504, and/or the tap tether ruler 506 are retractable. In certain embodiments, the distribution tether ruler 504 is retractable and fixedly attached to the end of the distribution cable ruler 502.

Referring to FIG. 7A, in certain embodiments, the measurement system 500′ includes a plurality of tap tether rulers 506(1)-506(4) attached to the distribution cable ruler 502. Accordingly, the tap tether rulers 506(1)-506(4) may set at the appropriate spacing S1-S3 on the distribution cable ruler 502. In other embodiments, a single tap tether ruler 506 is used, and the distribution cable ruler 502 is marked (e.g., with tape, marker, pen, etc.) to indicate each of the plurality of tap points along the length of the distribution cable ruler 502.

FIG. 8 is a close up of a collar 800 coupling the tap tether ruler 506 to the distribution cable ruler 502. In certain embodiments, the collar 800 is slidably coupled to the distribution cable ruler 502. In particular, the collar 800 is positioned around a distribution cable tube 600 of the distribution cable ruler 502. The tap tether ruler 506 is movably attached to the distribution cable ruler 502. Accordingly, the collar 800 and the tap tether ruler 506 can be slid along a length of the distribution cable ruler 502 to the appropriate point. In certain embodiments, the collar 800 is held in place relative to the distribution cable ruler 502 by friction. In certain embodiments, the collar 800 includes a first half-shell 802 snap-fit to a second half-shell 804. In certain embodiments, the tap tether ruler 506 is configured to be selectively fixed along a distribution cable length of the distribution cable ruler 502. For example, in certain embodiments, the collar 800 is fixed to the distribution cable ruler 502 by adhesive and/or clamps, etc.

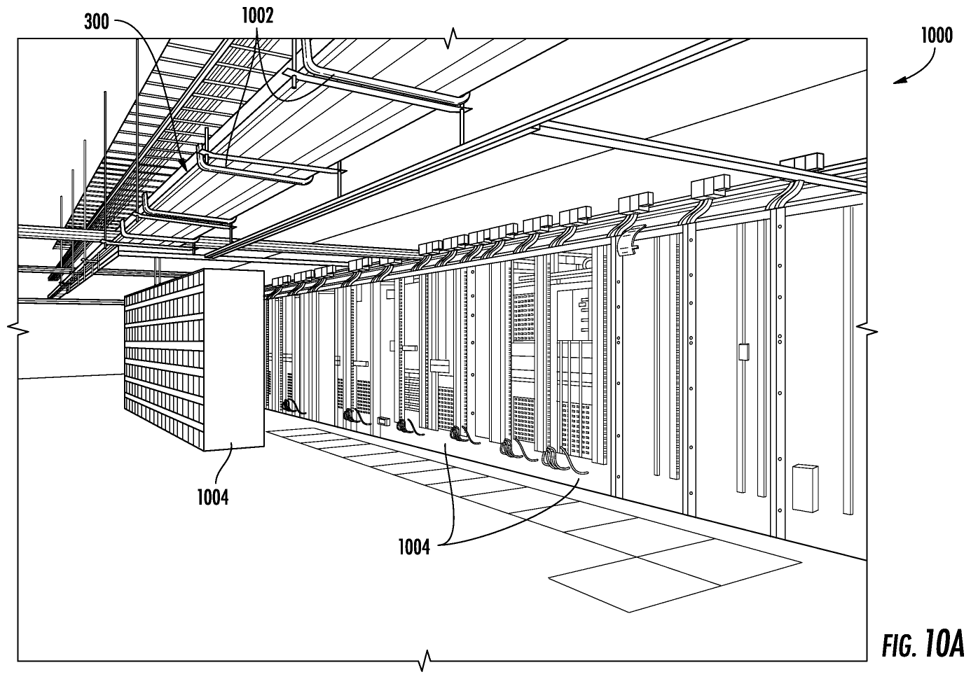

FIG. 9 is a perspective view of a measurement system 500 rolled up on a cable reel. In certain embodiments, the measurement system 500 can be unrolled to then measure the corresponding dimensions. In certain embodiments, after the distribution cable ruler 502 is marked and/or the tap tether rulers 506 are fixed in place relative to the distribution cable ruler 502, the measurement system 500 can be rolled back onto the reel for ease of shipment.

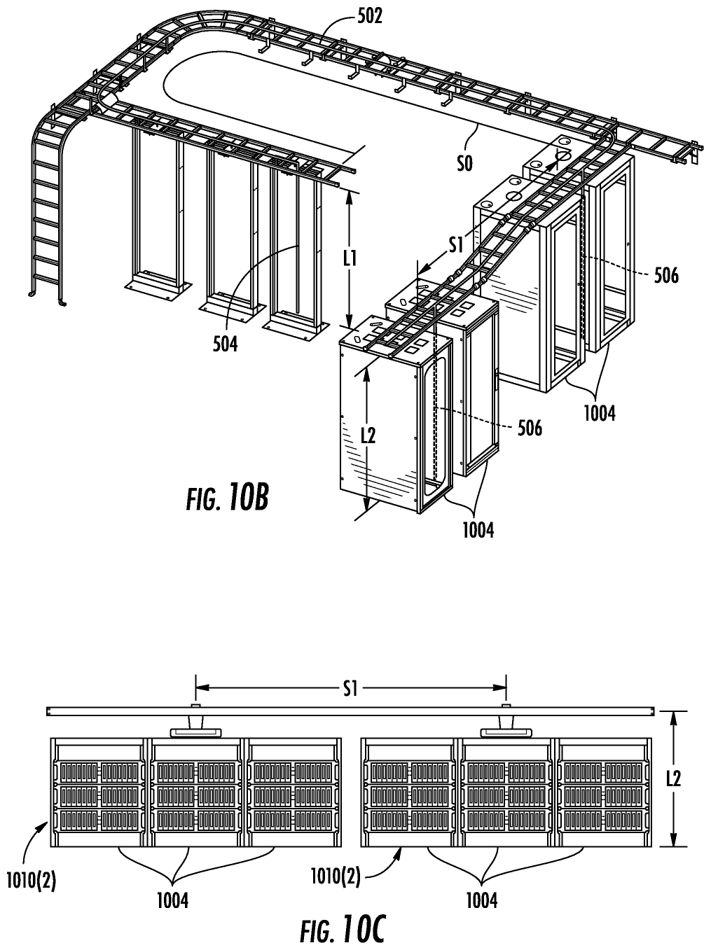

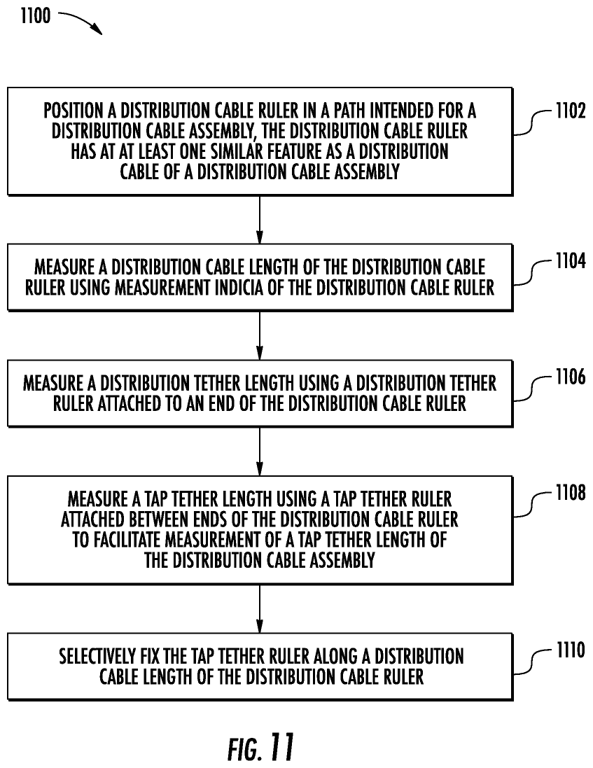

FIG. 10A is a perspective view of a data center 1000, including distribution cable assembly 300 suspended by straps 1002. In particular, the distribution cable 100 (see FIG. 3A) is routed among the various cabinets 1004, and the tap tethers 326 (see FIG. 3A) extend downward at each of a plurality of tap points.

FIG. 10B is a perspective view illustrating measurements by the measurement system of FIG. 5 of the distribution tether length, distribution cable length, and tap tether length. In particular, the distribution cable ruler 502 can be routed among the various straps to provide a total distribution cable length S0-S1. As noted above, the distribution cable ruler 502 mechanically behaves similarly to that of the distribution cable 100 to increase the accuracy of the measurements. The distribution tether ruler 504 measures the distribution tether length L1 at the first cabinet location. The tap tether ruler 506 measures the tap tether length L2 at the second cabinet location.

FIG. 10C is a side view of fiber optic cabinets 1004 illustrating measurements by the measurement system of FIG. 5 of tap spacing S1 and tap tether length L2. In particular, the distribution cable extends between the first cabinet group 1010(1) and the second cabinet group 1010(2). Further, it is noted that the tap tether length L2 is about the same for each of the first cabinet group 1010(1) and second cabinet group 1010(2). Accordingly, in certain embodiments, a single tap tether ruler 506 (see FIG. 5) is used to measure the tap tether length L2, and that dimension is applied to all of the cabinet groups 1010(1), 1010(2).

FIG. 11 is a flowchart 1100 of steps of measuring for manufacture and deployment of at least a portion of a distribution cable assembly 300, 300′, 300″. Step 1102 includes positioning a distribution cable ruler 502 in a path intended for a distribution cable assembly 300, 300′, 300″. The distribution cable ruler 502 has at least one similar feature as a distribution cable 100, 100′, 100″ of a distribution cable assembly 300, 300′, 300″. The at least one similar feature has at least one of an outer diameter, a bend radius, or a rigidity. Step 1104 includes measuring a distribution cable length of the distribution cable ruler 502 using measurement indicia 606 of the distribution cable ruler 502. Step 1106 includes measuring a distribution tether length using a distribution tether ruler 504 attached to an end of the distribution cable ruler 502. Step 1108 includes measuring a tap tether length using a tap tether ruler 506 attached between ends of the distribution cable ruler 502 to facilitate measurement of a tap tether length of the distribution cable assembly 300, 300′, 300″. Step 1110 includes selectively fixing the tap tether ruler 506 along a distribution cable length of the distribution cable ruler 502.

It will be apparent to those skilled in the art that various modifications and variations can be made without departing from the spirit or scope of the invention.

Further, as used herein, it is intended that terms “fiber optic cables” and/or “optical fibers” include all types of single-mode and multi-mode light waveguides, including one or more optical fibers that may be upcoated, colored, buffered, ribbonized, and/or have other organizing or protective structure in a cable such as one or more tubes, strength members, jackets or the like. Likewise, other types of suitable optical fibers include bend-insensitive optical fibers or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163.

Many modifications and other embodiments of the concepts in this disclosure will come to mind to one skilled in the art to which the embodiments pertain, having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A measurement system for manufacture and deployment of a distribution cable assembly, comprising:
a distribution cable ruler having at least one similar feature as a distribution cable of a distribution cable assembly, the at least one similar feature comprising at least one of an outer diameter, a bend radius, or a rigidity, the distribution cable ruler comprising measurement indicia to facilitate measurement of a distribution length of the distribution cable of the distribution cable assembly.

2. The measurement system of claim 1, wherein the measurement indicia is applied to an outer surface of a distribution cable tube of the distribution cable ruler.

3. The measurement system of claim 1,
wherein the measurement indicia is applied to a flexible tape measure positioned within a distribution cable tube of the distribution cable ruler;
wherein at least a portion of the distribution cable tube is transparent.

4. The measurement system of claim 1, wherein the measurement indicia comprises at least English length measurement units or metric length measurement units.

5. The measurement system of claim 1, further comprising a distribution tether ruler attached to an end of the distribution cable ruler to facilitate measurement of a distribution tether length of the distribution cable assembly.

6. The measurement system of claim 5, wherein the distribution tether ruler of the distribution cable assembly has at least one similar feature as a distribution tether of a distribution cable assembly, the at least one similar feature comprising at least one of an outer diameter, a bend radius, or a rigidity.

7. The measurement system of claim 5, wherein the distribution tether ruler is retractable.

8. The measurement system of claim 5, wherein the distribution tether ruler is fixedly attached to the end of the distribution cable ruler.

9. The measurement system of claim 1, further comprising a tap tether ruler attached between ends of the distribution cable ruler to facilitate measurement of a tap tether length of the distribution cable assembly.

10. The measurement system of claim 9, wherein the tap tether ruler has at least one similar feature as a tap tether of a distribution cable assembly, the at least one similar feature comprising at least one of an outer diameter, a bend radius, or a rigidity.

11. The measurement system of claim 9, wherein the tap tether ruler is retractable.

12. The measurement system of claim 9, wherein the tap tether ruler is movably attached to the distribution cable ruler.

13. The measurement system of claim 9, wherein the tap tether ruler comprises a collar positioned around a distribution cable tube of the distribution cable ruler.

14. The measurement system of claim 13, wherein the collar comprises a first half-shell snap-fit to a second-half shell.

15. The measurement system of claim 9, wherein the tap tether ruler is configured to be selectively fixed along a distribution length of the distribution cable ruler.

16. The measurement system of claim 1, further comprising a plurality of tap tether rulers attached between ends of the distribution cable ruler to facilitate measurement of a tap tether length of the distribution cable assembly.

17. A method of measuring for manufacture and deployment of a distribution cable assembly, comprising:
positioning a distribution cable ruler in a path intended for a distribution cable assembly, the distribution cable ruler having at least one similar feature as a distribution cable of a distribution cable assembly, the at least one similar feature comprising at least one of an outer diameter, a bend radius, or a rigidity;
measuring a distribution cable length of the distribution cable ruler using measurement indicia of the distribution cable ruler.

18. The method of claim 17, measuring a distribution tether length using a distribution tether ruler attached to an end of the distribution cable ruler.

19. The method of claim 17, measuring a tap tether length using a tap tether ruler attached between ends of the distribution cable ruler to facilitate measurement of the tap tether length of the distribution cable assembly.

20. The method of claim 19, further comprising selectively fixing the tap tether ruler along a distribution cable length of the distribution cable ruler.
